(19) United States
(12) Patent Application Publication
(10) Pub. No.: US 2023/0336402 A1
(43) Pub. Date: Oct. 19, 2023

(54) EVENT-DRIVEN PROBABLE CAUSE ANALYSIS (PCA) USING METRIC RELATIONSHIPS FOR AUTOMATED TROUBLESHOOTING

(71) Applicant: Cisco Technology, Inc., San Jose, CA (US)

(72) Inventors: Walter Hulick, JR., Pearland, TX (US); Carlos M. Pignataro, Cary, NC (US); David Zacks, Vancouver (CA); Thomas Szigeti, Vancouver (CA); Hans F. Ashlock, Berkeley, CA (US)

(21) Appl. No.: 17/722,518

(22) Filed: Apr. 18, 2022

(51) Int. Cl. H04L 41/0631; H04L 43/16

(52) U.S. Cl. CPC H04L 41/0631; H04L 43/16

(57) ABSTRACT

Data related to operational performance of a plurality of nodes in a system is obtained and a first metric anomaly associated with a node of the plurality of nodes in the system is identified. The first metric anomaly indicates that data associated with a first metric is outside a threshold range. Second metrics related to the first metric are identified and it is determined that one of the second metrics is an anomaly. Third metrics related to the second metric are identified and it is determined whether any third metric is an anomaly. The second metric is identified as a probable cause of the first metric anomaly when it is determined that no third metric is an anomaly. A report including information associated with the probable cause of the first metric anomaly is transmitted to a user device.

### TECHNICAL FIELD

The present disclosure relates to troubleshooting performance issues.

### BACKGROUND

When information technology (IT) outages or performance issues occur that impact an enterprise, a team of IP professionals manually review metrics, events, and alerts to attempt to find the probable cause of the outage or performance issue. Performing a manual review is time consuming and error prone and can impact mean time to repair, mean time to recover, and mean time to diagnose.

### BRIEF DESCRIPTION OF THE DRAWINGS

FIG. 1 is a block diagram of a system configured to support identifying a probable cause of a root metric anomaly, according to an example embodiment.

FIG. 2 illustrates an example metric relationship dictionary table, according to an example embodiment.

FIG. 3 illustrates an example metric access adaptors table, according to an example embodiment.

FIG. 4 illustrates an example metric relationship groups table, according to an example embodiment.

FIG. 5 is a flow diagram illustrating a method of performing a related metrics traversal to identify a probable cause of a root metric anomaly, according to an example embodiment.

FIG. 6 is a diagram illustrating another method of performing a related metrics traversal to identify a probable cause of a root metric anomaly, according to an example embodiment.

FIG. 7 is a flow diagram illustrating a method of identifying a probable cause of a root metric anomaly, according to an example.

FIG. 8 is a hardware block diagram of a device that may be configured to perform the operations involved in identifying a probable cause of a root metric anomaly, according to an example embodiment.

### DESCRIPTION OF EXAMPLE EMBODIMENTS

### Overview

In one embodiment, a method is provided for identifying a probable cause of a performance event associated with a metric anomaly at a node of a system. The method includes obtaining data related to operational performance of a plurality of nodes in a system, wherein each node of the plurality of nodes is a compute device, a storage device, or a networking device. The method further includes identifying a first metric anomaly associated with a node of the plurality of nodes in the system. The first metric anomaly indicates that data associated with a first metric is outside a threshold range. The method further includes identifying one or more second metrics related to the first metric and determining that a second metric of the one or more related second metrics is an anomaly. The method further includes identifying one or more third metrics related to the second metric and determining whether any third metric of the one or more third metrics is an anomaly. The method additionally includes identifying the second metric as a probable cause of the first metric anomaly when it is determined that no third metric anomaly is an anomaly and transmitting, to a user device, a report including information associated with the probable cause of the first metric anomaly.

### Example Embodiments

When an IT outage or performance issue occurs, a system is needed that can receive information associated with a single health event and automate a probable cause response with supporting forensics and artifacts in minutes instead of in hours or days. Machine learning (ML) and artificial intelligence (AI) solutions may be helpful, but they have several basic flaws. First, ML and AI solutions are unable to determine relationships between metrics. Instead, ML and AI solutions merely determine which metrics are “out of bounds” and automatically assume that metrics that are out of bounds are related, when frequently they are unrelated. Second, ML and AI systems require receipt all of the metric data at one time without any intelligence in terms of incremental analysis when requesting metric data. In this way, ML and AI solutions query and evaluate metrics that are not related to the issue causing the outage or performance issue, which causes unnecessary resource overhead and latency.

Embodiments described herein provide for automatically following a metric traversal path of related metrics and determining whether any of the metrics along the traversal path are anomalies to identify a probable cause of a root metric that is causing a performance event. The metric traversal path is built based on metric relationship data that takes an initial metric that caused a performance event (e.g., an outage or performance issue) and associates downstream metrics that are related to the initial metric. Following the metric traversal path to determine related metrics that are anomalies leads to identifying metrics that are the probable cause of the performance event. The automated metric traversal path provides an efficient and accurate method for identifying a probable cause of a root metric anomaly while reviewing a smaller number metrics than in other algorithms or methods.

Embodiments described herein further provide for calculating an anomaly score for each metric in the metric traversal path. The anomaly score is calculated based on a moving average and standard deviation. If the anomaly score for a metric is out of a threshold range for the metric, information associated with the metric is placed in an anomaly capture queue and included in a report associated with the performance event. In addition, metrics related to the anomalous metric are identified and anomaly scores for the related metrics are calculated. If the anomaly scores are within threshold ranges for the metrics, the metric traversal path is terminated and the last identified anomalous metric is identified as a probable cause of the performance event.

When the metric traversal path is terminated, a report and/or graph of the metric traversal path/metric dependencies is generated and transmitted to one or more users as an automated response to the performance event. The report may include metadata probable cause analysis (PCA) artifacts (e.g., snapshots) to support the analysis. The report may additionally include information for remedying a root metric anomaly associated with a node that triggered the related metric traversal path. A node is an “instrumented” downstream service component (capable of providing metrics) that is a part of a transaction flow. A node may be an application, a network component, a gateway, and/or any other entity critical to the performance and integrity of the transaction. The report may additionally include information associated with nodes, metric chains, and scores associated with the probable cause analysis. For example, the report may include a score associated with the probable cause that is an aggregate of anomaly scores linked to a root metric.

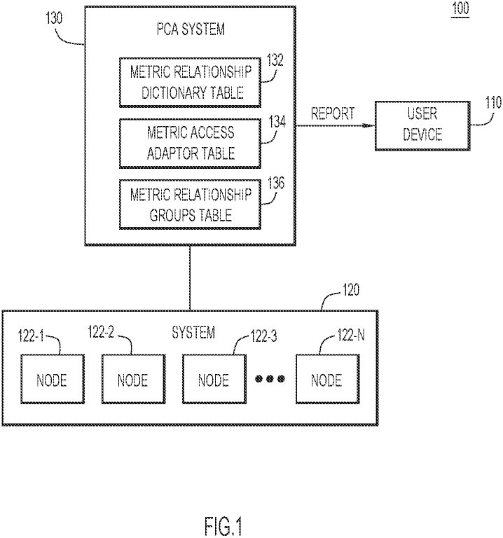

Reference is first made to FIG. 1. FIG. 1 shows a block diagram of an environment 100 that is configured to identify a probable cause of a performance event. The environment 100 includes a user device 110, a system 120, and a PCA system 130. The system 120 includes nodes 122-1 to 122-N and the PCA system 130 includes metric relationship dictionary table 132, metric access adaptors table 134, and metric relationship groups table 136. System 120 may be a system associated with a company, organization, enterprise, etc. that includes a plurality of nodes 122-1 to 122-N. Nodes 122-1 to 122-N are entities (e.g., devices (compute device, storage devices, networking devices, etc.), hardware, software, etc.) associated with system 120.

A particular node (e.g., node 122-1) may include several other nodes (e.g., node entry point, node exit point, etc.). In some embodiments, a node may be a logical entity that may map to one or more physical entities in various ways (e.g., 1:1, n:1, 1:n, etc.). system 120 may include any number of nodes (e.g., hundreds or thousands of nodes) and the nodes may be different types of nodes that are located in different areas and are associated different types of query formats and authentication mechanisms (e.g., to access current metric information).

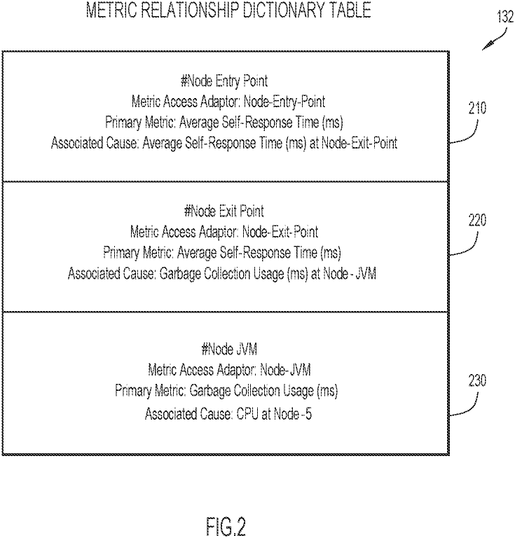

PCA system 130 is configured to identify a probable cause of a performance event by traversing a metric traversal path of related metrics. As described further below with respect to FIGS. 2-4, PCA system 130 uses metric relationship dictionary table 132, metric access adaptors table 134, and metric relationship groups table 136 to traverse the metric traversal path to identify the probable cause(s) of a performance event. PCA system 130 is additionally configured to automatically generate a report that includes the probable cause(s) of the performance event (and additional information) and transmit the report to one or more devices, such as user device 110. User device 110 may be associated with a support or help desk, an administrator, an IT professional, or another user associated with system 120.

User device 110 may be a tablet, laptop computer, desktop computer, Smartphone, virtual desktop client, virtual whiteboard, or any user device now known or hereinafter developed that can receive the report from PCA system 130. User device 110 may have a dedicated physical keyboard or touch-screen capabilities to provide a virtual on-screen keyboard to enter text. User device 110 may also have short-range wireless system connectivity (such as Bluetooth™ wireless system capability, ultrasound communication capability, etc.) to enable local wireless connectivity.

In the example described with respect to FIG. 1, a performance event associated with system 120 has been detected by PCA system 130. A performance event is associated with a node and a metric that triggers the performance event (i.e., the root metric). For example, the node may be node entry point at node 122-1 and the root metric may be average self-response time in milliseconds (ms). The performance event may be associated with an issue experienced by a user at a particular node or device. For example, a user may be experiencing a slow response time when accessing services provided by a particular node or device. A performance event may be identified when the root metric at a node is an anomaly (i.e., an anomaly score associated with the root metric is outside of a threshold range for the metric). Therefore, in this example, the PCA session starts by determining that an anomaly score associated with the average self-response time at node entry point at node 122-1 is outside of a threshold (e.g., the response time is slow).

There are two types of anomaly thresholds - relative and independent. When the anomaly threshold is relative, a current metric is compared against a portion of a historical value or trend for the metric (e.g., a moving average). When the anomaly threshold is independent, the current metric is compared against a threshold or value that is unrelated to the metric’s historical values.

There are multiple anomaly calculation types for determining whether a metric is an anomaly. One anomaly calculation type is a baseline deviation scorer, which uses a comparison of the current vertex metric (1 minute average) against the baseline deviation of the same metric. Another anomaly calculation type is an exponential moving average scorer, which uses a comparison of a current vertex metric (1 minute average) against the exponential moving average for the same metric. Yet another anomaly calculation type is a static threshold scorer, which uses a comparison of the current vertex metric (1 minute average) against a static threshold of the same metric.

In many situations, a metric anomaly at one node may be caused by a related metric anomaly at another node in system 130. For example, the slow self-response time at node entry point at node 122-1 may be caused by metric anomalies at other nodes, such as, for example, node exit point on node 122-2 or node JVM at node 122-3 in system 130. In other words, the slow self-response time at node entry point on node 122-1 may be caused by an anomaly score of a related metric at another node being outside of a threshold range. A related metric contributing to the performance event or issue experienced by the user (e.g., slow response time) may be an underlying metric on a different device or node than the device or node that is experiencing the slow response time. In some situations, the related metric anomalies may not affect the user who is experiencing the issue causing the performance event. To identify a probable cause of a root metric anomaly associated with a performance event, PCA system 130 may identify metrics related to the root metric and determine whether any of the related metrics are anomalies.

To identify metrics that are related to a metric, a lookup may be performed in metric relationship dictionary table 132, which stores metric relationship data that maps metrics to one or more related metrics. In the example described with respect to FIG. 1, when the performance or trigger event has been identified (e.g., a slow average self-response time at node entry point at node 122-1), PCA system 130 performs a lookup in metric relationship dictionary table 132 using the source (e.g., node entry point on node 122-1) and the primary metric (e.g., average self-response time) to determine metrics that are related to the root metric.

Reference is now made to FIG. 2 with continued reference to FIG. 1. FIG. 2 illustrates metric relationship dictionary table 132. Metric relationship dictionary table 132 stores metric relationship data and includes entry 210, entry 220, and entry 230. Although only three entries are illustrated, metric relationship dictionary table 132 may include any number of entries. Information included in entries 210-230 is exemplary only.

Each entry in metric relationship dictionary table 132 maps a metric to one or more related metrics. Each entry includes a node name, a metric access adaptor field, a primary metric field, and an associated cause field. For example, entry 210 is an entry associated with node “entry point” with a primary metric of average self-response time in milliseconds. Therefore, in the example discussed above, when a performance event is triggered by identifying a metric anomaly associated with the average self-response time at node “entry point” on node 122-1, PCA system 130 may perform a lookup in metric relationship dictionary table 132 and identify entry 210. Entry 210 additionally indicates that the associated cause is the average self-response time at the node “exit point” (e.g., on node 122-2). The associated cause field lists one or more metrics that are related to the metric associated with an entry. In this case, the average self-response time at node “exit point” (e.g., on node 122-2) is related to and may affect the average self-response time at node “entry point” on node 122-1. Although entry 310 lists only one related metric in the associated cause field, in some embodiments, more than one related metric may be listed in the associated cause field.

To determine whether a metric associated with a node is an anomaly, PCA system 130 calculates an anomaly score for the metric. To determine the anomaly score, PCA system 130 accesses a current value for the metric. For example, PCA system 130 may query the metric average for a specified time period and for a specified source (e.g., node) and metric and convert the metrics to a moving average. The moving average may be compared against the anomaly calculation type discussed above to determine whether an anomaly exists.

As discussed above, nodes 122-1 to 122-N in system 120 may be at different locations and may require different query formats and authentication mechanisms for retrieving metric information. To access a current metric (e.g., metric average for a time period) for a node, PCA system 130 determines how to access the metric for the node and identifies the query format and authentication mechanism to use to make the query for the particular node. The metric adapter field in metric relationship dictionary table 132 provides information identifying an entry in metric access adaptors table 134 where the information needed to access the current metric for the node is stored. As illustrated in entry 210, the information needed to obtain the current average self-response time for node “entry point” may be located by identifying the “Node-Entry-Point” entry in metric access adaptors table 134.

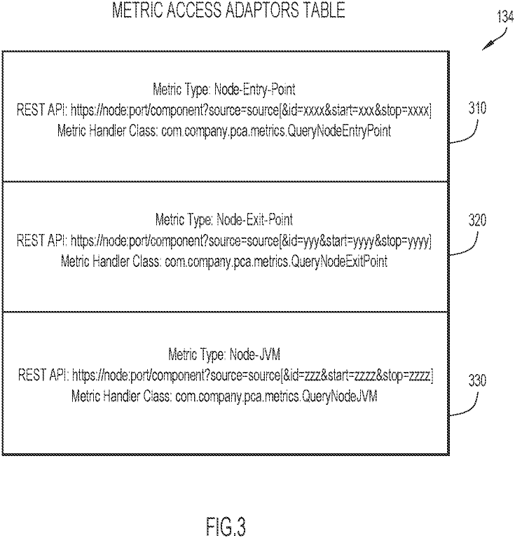

Reference is now made to FIG. 3 with continued reference to FIGS. 1 and 2. FIG. 3 illustrates a metric access adaptors table 134 that includes entries 310, 320, and 330. Although only three entries are illustrated in FIG. 3, metric access adaptors table 134 may include any number of entries. Information included in entries 310, 320, and 330 is exemplary only.

Each entry in metric access adaptors table 134 stores metric access adaptor data and includes a field for the representational state transfer (REST) application programming interface (API) and a field for the metric handler class associated with a node corresponding to the entry. The REST API field indicates the REST API to use for accessing metrics associated with the particular node. The metric handler class field indicates information to use to identify the query format and authentication mechanism to use to make a query for the particular node and how to retrieve the metric(s) associated with the particular node.

Entry 310 of FIG. 3 is an entry for the metric type “Node-Entry-Point.” Entry 310 includes information with the node “entry point” described above with respect to entry 210 in FIG. 2. Entry 310 indicates that the REST API associated with the node “entry point” is https://node:port/component?source=source[&id=xxxx&start=xxx&stop=xxxx] and the metric handler class associated with the node “entry point” may be located at com.company.pca.metrics.QueryNodeEntryPoint. The REST API may be used to access the metrics associated the node “entry point” and the query format and authentication mechanism associated with the node “entry point” may be located using the information indicated by the metric handler class.

In the example discussed above, PCA system 130 has determined, from entry 210, that the average self-response time at node “exit point” on node 122-2 is related to the average self-response time at node “entry point” on node 122-1. When PCA system 130 has identified metrics related to the root metric, PCA system 130 may determine whether any of the related metrics are anomalies. To determine whether the average self-response time at node “exit point” on node 122-2 is an anomaly, PCA system 130 may identify the current self-response time at node “exit point” on node 122-2 to calculate an anomaly score. PCA system 130 may perform a lookup in metric relationship dictionary table 132 to locate the metric access adaptor field associated with node “exit point.”

entry 220 of FIG. 2 illustrates the entry associated with the average self-response time for node “exit point.” entry 220 indicates that for node “exit point,” the metric access adaptor information may be located at entry “Node-Exit-Point” in metric access adaptors table 134.

Entry 320 of FIG. 3 illustrates the metric adapter information associated with “Node-Exit-Point.” Entry 320 of FIG. 3 identifies a REST API at https://node:port/component?source=source[&id=yyy&start=yyyy&stop=yyyy] and metric handler class information at com.company.pca.metrics.QueryNodeExitPoint. PCA system 130 may use the REST API and the metric handler class information in entry 320 to obtain the current self-response time (e.g., a moving average) at node “exit point” on node 122-2. PCA system 130 may calculate an anomaly score for the self-response time at node “exit point” on node 122-2 using the current metric information to determine whether the metric is an anomaly.

In this example, PCA system 130 has determined that the average self-response time at node “exit point” on node 122-2 is an anomaly. PCA system 130 stores information associated with the anomaly in an anomaly capture queue to be included in a probable cause analysis report. Since a metric anomaly at one node may be caused by a metric anomaly at another node, PCA system 130 performs another lookup in metric relationship dictionary table 132 to determine metrics related to the average self-response time at node “exit point” on node 122-2. As illustrated in entry 220 of metric relationship dictionary table 132, the associated cause field indicates that the garbage collection usage (ms) at node “JVM” (e.g., on node 122-3) is related to the average self-response time at node “exit point” on node 122-2.

To determine whether the garbage collection usage at node “JVM” on node 122-3 is an anomaly, PCA system 130 performs a lookup in metric relationship dictionary table 132 and identifies entry 230 as an entry associated with garbage collection usage at node “JVM.” PCA system 130 determines, from the metric access adaptor field in entry 230, that “Node-JVM” is to be used to perform a lookup in metric access adaptors table 134 to obtain information to use to access current metric information associated with node “JVM.”

Entry 330 in FIG. 3 corresponds to node “JVM” and identifies a REST API at https://node:port/component?source=source[&id=zzz&start=zzzz&stop=zzzz] and metric handler class information at com.company.pca.metrics.QueryNodeEntryPointDownstream. Using the REST API and metric handler class information located in entry 330, PCA system 130 identifies current garbage collection usage information for node “JVM” on node 122-3 and calculates an anomaly score.

In this example, PCA system 130 determines, based on the anomaly score, that the garbage collection usage at node “JVM” on node 122-3 is an anomaly. PCA system 130 stores information associated with the anomaly in the anomaly capture queue and performs a lookup in entry 230 in metric relationship dictionary table 132 to determine that the metric CPU at Node-5 (e.g., on node 122-N) is related to the garbage collection usage at node “JVM” on node 122-3. PCA system 130 performs an additional lookup in metric relationship dictionary table 132 to identify an entry corresponding to the metric CPU at Node-5 (the entry is not illustrated in FIG. 2). Based on the entry, PCA system 130 identifies metric access adaptor information for performing a lookup in metric access adaptors table 134 for determining a current value for the metric CPU at Node-5. In this example, PCA system 130 determines that the current value for the metric CPU at Node-5 is within a threshold range for the metric.

When PCA system 130 determines that a metric is not an anomaly (i.e., the metric is within a threshold range for the metric), PCA system 130 identifies the last identified metric anomaly in the metric anomaly traversal path as the probable cause of the metric root anomaly. In this example, the last identified metric anomaly in the metric anomaly traversal path is the garbage collection usage at node “JVM” on node 122-3. Therefore, in this example, PCA system 130 determines that garbage collection usage at node “JVM” on node 122-3 is the probable cause of the average self-response time anomaly at node “entry point” on node 122-1.

According to embodiments described herein, PCA system 130 continues to traverse a related metric anomaly traversal path using metric relationship dictionary table 132 and metric access adaptors table 134 until no anomalous metric is identified. When no related metrics are anomalies, PCA system 130 identifies the last identified related metric anomaly or anomalies as the probable cause(s) of the metric root anomaly.

In some cases, looping may occur when following a related metric anomaly traversal path. For example, for the event trigger “metric average self-response time (ms) at Node-Entry-Point for Node 122-1, the traversal may include (1) metric average self-response time (ms) at Node-Entry-Point (node 122-1) → (2) metric average self-response time (ms) at Node-Exit-Point (node 122-1) → (3) metric average self-response time (ms) at Node-Entry-Point-Downstream → Translates/Loops to → (4) metric average self-response time (ms) at Node-Entry-Point (Node 122-2...Node 122-N). In this example, the loop repeats itself until all nodes 122-1 to 122-N have been exhausted for each downstream node (or until no additional anomalies are identified).

When the probable cause of the metric root anomaly is identified, PCA system 130 automatically generates a PCA report (e.g., using information stored in the anomaly capture queue) and transmits the PCA report to one or more devices, such as user device 110. The PCA report includes information identifying the probable cause, information identifying the anomalies identified during the related metric anomaly traversal path, information associated with the analysis (e.g., resources used during the analysis, how long the analysis took, number of related metrics identified, etc.) and possibly supporting data relevant to the incident or performance event (e.g., snapshots associated with performance event and/or other related metric anomalies). In some embodiments, the PCA report may additionally include information associated with actions to perform to bring the data associated with the root metric anomaly into the threshold range and/or ways to adjust a configuration of one or more of the nodes in the system to remedy the root metric anomaly. The PCA report may additionally include a score associated with the probable cause. The score associated with the probable cause may be an aggregate of scores calculated while following the metric anomaly traversal path (i.e., an aggregate of anomaly scores of the anomalies identified during the analysis).

For the analysis described above with respect to FIG. 1, the PCA system 130 may produce the following PCA report:

On Oct. 30, 2021, a Probable Cause Analysis was trigger by Metric “Metric Average Self Response Time (ms)@ Node-Entry-Point on Node 122-1” exceeding the Baseline Deviation by 4.45 times

Resource Audit:
Metric Calls: 325
CPU Used:11200 ms
Analysis Latency:22434 ms

The Analysis and revealed 3 anomalies:
Metric Average Self Response Time (ms) @ Node-Entry-Point on Node 122-1 exceeding 10 minute moving average by 5 times
Metric Average Self Response Time (ms) @ Node-Exit-Point on Node 122-2 exceeding 10 minute moving average by 5 times
Garbage Collection Usage (ms) @ Node-JVM on Node 122-3 exceeding 10 minute Moving average by 100 times

The following links contains supporting data relevant to the incident:
https://host:port/aaa/bbb
https://host:port/ccc/ddd
https://host:port/eee/fff

This example PCA report includes data related to the audit/analysis (e.g., number of metric calls, resources used, analysis latency), information about the identified metric anomalies (e.g., metric type, metric node, and an indication of how much the anomaly score exceeded a 10 minute moving average), and information supporting data relevant to the performance event (e.g., links to snapshots with supporting information). In some cases, the PCA report may include additional or different information. This example PCA report indicates that nodes 122-1, 122-2, and 122-3 were all impacted by the garbage collection usage at node 122-3. Essentially, in this example, the garbage collection CPU usage “starved” node 122-3 and impacted its response time to the transactions. The anomalies at nodes 122-1 and 122-2 were likely caused by the issues on node 122-3.

The PCA report may additionally include information associated with the nodes, metric chains, and scores (e.g., anomaly scores) calculated during the probable cause analysis. In one embodiment, the PCA report may include a score calculated for the determined probable cause as an aggregate of anomaly scores linked to the root metric. In this example, the PCA report may include a score for the garbage collection usage at node 122-3 that may be an aggregate of the anomaly score calculated for the garbage collection usage at node 122-3, the anomaly score calculated for the metric average self-response time at node “exit point” on node 122-2, and the anomaly score calculated for the average self-response time at node “entry point” on node 122-1.

In response to the PCA report being transmitted to one or more devices, an adjustment of a configuration of one or more of the plurality of nodes in the system may be made to remedy the root metric anomaly based on the information contained in the PCA report. For example, one or more users may perform steps to bring the root metric anomaly into the threshold range based on information included in the PCA report. As another example, a device or system may automatically adjust configurations based on information in the PCA report.

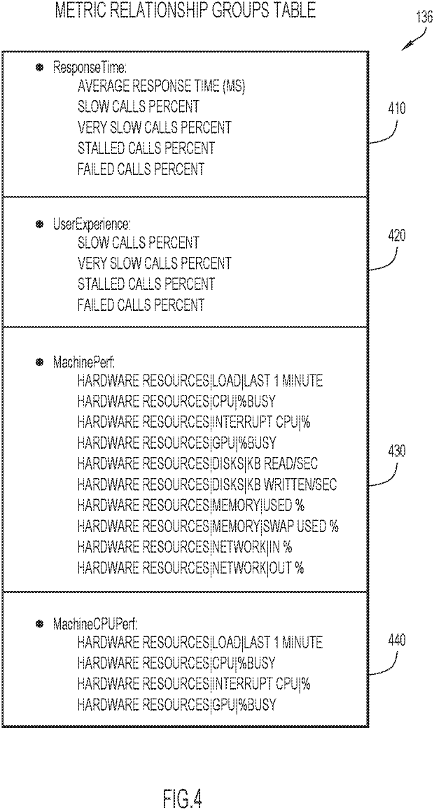

Reference is now made to FIG. 4 with continued reference to FIGS. 1-3. FIG. 4 illustrates metric relationship groups table 136 that includes entries 410, 420, 430 and 440.

Some metrics that are similar may be grouped into categories and given a group name. For example, entry 410 indicates that the metrics “average response time (ms),” “slow calls percent,” “very slow calls percent,” “stalled calls percent,” and “failed calls percent” can all be grouped together under the group “ResponseTime.” Entry 420 indicates that the metrics “slow calls percent,” “very slow calls percent,” and “failed calls percent” can be grouped together under the name “UserExperience.” Entry 430 indicates that the metrics “hardware resources | load | last 1 minute,” “hardware resources | CPU | % busy,” “hardware resources | interrupt CPU | %,” “hardware resources | GPU | %busy,” “hardware resources | disks | KB read/sec,” “hardware resources | disks | KB written/sec,” “hardware resources | memory | used %,” “hardware resources | memory | swap used %,” “hardware resources | network | in %,” and “hardware resources | network | out %” are all related to machine performance and may be grouped under the name “MachinePerf.” Entry 440 indicates that the metrics “hardware resources | load | last 1 minute,” “hardware resources | CPU | % busy,” “hardware resources | interrupt CPU | %,” and “hardware resources | GPU | %busy” may be grouped under the name “MachineCPUPerf.”

In many situations, if one of the metrics in a group is a related metric in metric relationship dictionary table 132, then other metrics in the groups are also related metrics. Additional metrics may be added to different groups as needed. In this way, related metrics may be easily determined without changing the related metrics or dependencies in metric relationship dictionary table 132.

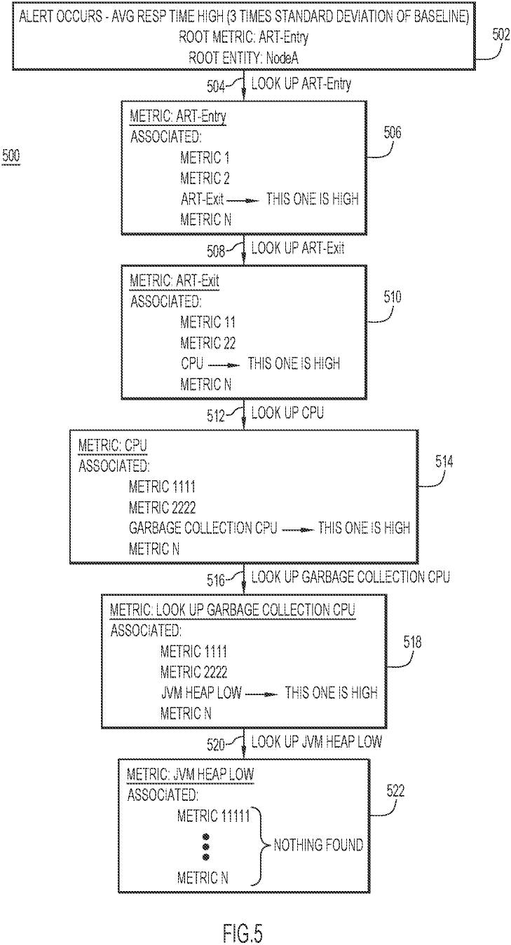

Reference is now made to FIG. 5 with continued reference to FIGS. 1-4. FIG. 5 is a flow diagram illustrating a method 500 of performing a related metrics traversal to determine a probable cause of a performance event. Method 500 may be performed by PCA system 130.

Method 500 begins at 502 with PCA system 130 receiving an alert indicating that the average response time of root metric ART-Entry at NodeA is high. In this example, the average response time is three times the standard deviation of the baseline value for the metric. At 504, PCA system 130 performs a lookup in metric relationship dictionary table 132 to determine metrics related to the metric ART-Entry (i.e., the root metric). At 506, PCA system 130 determines that the related metrics include Metric 1, Metric 2, ART-Exit, and Metric N. PCA system 130 determines current values (e.g., moving averages) for the related metrics (e.g., by performing lookups for the metrics in metric access adaptors table 134 to identify the REST API and metric handler class for obtaining the current values) and determines whether a current metric value for each metric is within a threshold range for the metric. In this example, the current value for the metric ART-Exit is high (i.e., above the threshold range) and, therefore, the metric ART-Exit is an anomaly. In this example, Metric 1, Metric 2, and Metric N are not anomalies.

At 508, PCA system 130 performs a lookup in metric relationship dictionary table 132 to identify metrics related to the metric ART-Exit. At 510, PCA system 130 identifies Metric 11, Metric 22, CPU, and Metric N as metrics related to the metric ART-Exit. PCA system 130 obtains current values for the related metrics in a manner described above and determines that the metric CPU is high (e.g., an anomaly score for CPU is not within a threshold range). In this example, the metric CPU is an anomaly and the metrics Metric 11, Metric 22, and Metric N are not anomalies.

At 512, PCA system 130 performs a lookup in metric relationship dictionary table 132 to identify metrics related to the metric CPU and, at 514, determines that Metric 111, Metric 222, Garbage Collection CPU, and Metric N are related to the metric CPU. PCA system 130 obtains current values for the related metrics and determines that the current value for the metric Garbage Collection CPU is high (e.g., an anomaly score is not within a threshold range). In this example, the metric Garbage Collection CPU is an anomaly and the metrics Metric 111, Metric 222, and Metric N are not anomalies.

At 516, PCA system 130 performs a lookup in metric relationship dictionary table 132 to identify metrics related to the metric Garbage Collection CPU At 518, PCA system 130 identifies that metrics Metric 1111, Metric 2222, JVM Heap Low, and Metric N are related to Garbage Collection CPU. PCA system 130 obtains current values for the related metrics and determines that metric JVM Heap Low is high (e.g., an anomaly score is not within a threshold range). In this example, the metric JVM Heap Low is an anomaly and the metrics Metric 1111, Metric 2222, and Metric N are not anomalies.

At 520, PCA system 130 performs a look up in metric relationship dictionary table 132 to identify metrics related to metric JVM Heap Low. At 522, PCA system 130 identifies Metrics 11111 to Metric N as related metrics and identifies that all of the related metrics are within threshold ranges for the metrics. Since none of the related metrics is an anomaly, PCA system 130 identifies the last identified metric anomaly as a probable cause of the root metric anomaly. In this example, PCA system 130 identifies JVM Heap Low as a probable cause of the root metric anomaly. PCA system 130 automatically generates a PCA report with information associated with the analysis, information identifying the identified anomalies, and possibly with supporting information (e.g., snapshots) and/or ways to remedy the root metric anomaly and transmits the PCA report to one or more devices (e.g., user device 110).

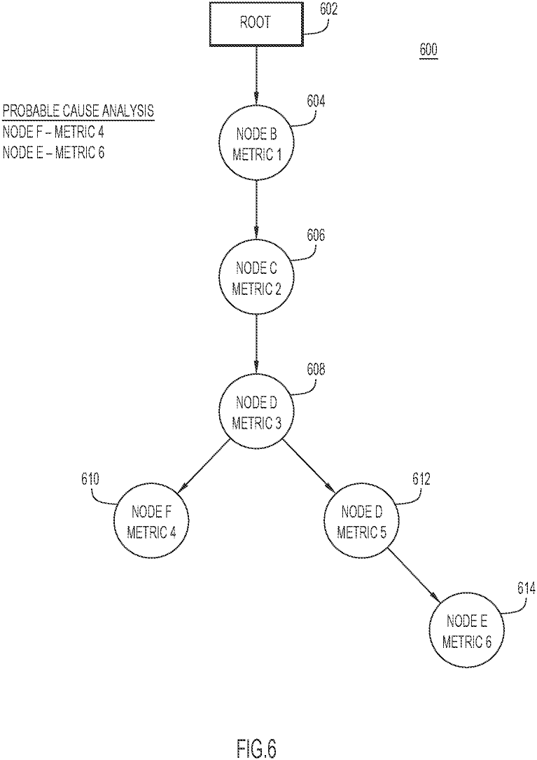

Reference is now made to FIG. 6 with continued reference to FIGS. 1-5. FIG. 6 is a flow diagram illustrating a method 600 of performing a related metrics traversal to determine probable causes of a performance event. Method 600 may be performed by PCA system 130.

At 602, a PCA session begins with a trigger that indicates an occurrence of a performance event. The performance event includes a metric source or entity (e.g., a node) and a metric that triggers the performance event (i.e., a root metric) based on an anomaly score. PCA system 130 performs a lookup in metric relationship dictionary table 132 to identify metrics related to the root metric and determines whether any of the related metrics are anomalies using methods described above.

At 604, PCA system 130 determines that metric 1 at node B is a related metric that is an anomaly. PCA system 130 performs a lookup in metric relationship dictionary table 132 to identify metrics related to metric 1 at node B and determines whether any of the related metrics are anomalies. At 606, PCA system 130 determines that metric 2 at node C is a related metric that is anomaly. PCA system 130 performs a lookup in metric relationship dictionary table 132 to identify metrics related to metric 2 at node C and determines whether any of the related metrics are anomalies.

At 608, PCA system 130 identifies metric 3 at node D as a related metric that is an anomaly. PCA system 130 performs a lookup in metric relationship dictionary table 132 to identify metrics related to metric 3 at node D and determines whether any of the related metrics are anomalies. At 610, PCA system 130 identifies metric 4 at node F as a related metric that is an anomaly and, at 612, PCA system 130 identifies metric 5 at node D as a related metric that is an anomaly. In this example, both metric 4 at node F and metric 5 at node D are related to metric 3 at node D and are anomalies.

PCA system 130 performs a lookup in metric relationship dictionary table 132 to identify metrics related to metric 4 at node F and determines that no related metrics are anomalies. PCA system 130 additionally performs a lookup in metric relationship dictionary table 132 to identify whether any metric related to metric 5 at node D is an anomaly. At 614, PCA system 130 identifies that metric 6 at node E is a related metric that is an anomaly. PCA system 130 performs a lookup in metric relationship dictionary table 132 to identify metrics related to metric 6 at node E and determines that no related metric is an anomaly.

PCA system 130 identifies the last “leaf” or “leaves” in the related metric traversal path as probable causes of the performance event. In this example, the last two identified anomalies are metric 4 at node F and metric 6 at node E. Therefore, the probable cause analysis identifies metric 4 at node F and metric 6 at node E as the probable causes of the root metric anomaly triggering the performance event. PCA system 130 automatically generates a PCA report including the probable causes, the anomalies identifies during the analysis, and possibly additional information (e.g., statistics associated with the analysis, snapshots, remedies, etc.). PCA system 130 transmits the PCA report to one or more devices (e.g., user device 110).

Since only the “leaves” in the traversal that indicate anomalies are followed, the number of queries and processing time required to perform the probable cause analysis are greatly reduced. Additionally, since the traversal follows metrics that are known to be related, false positive anomalies are removed. For example, in some situations, there may be a metric anomaly in a system that is not related to or contributing to the root metric anomaly. By following only related metric anomalies, time and resources are saved by not performing an analysis on metrics that are not related to the root metric or other metrics on the related metric traversal path.

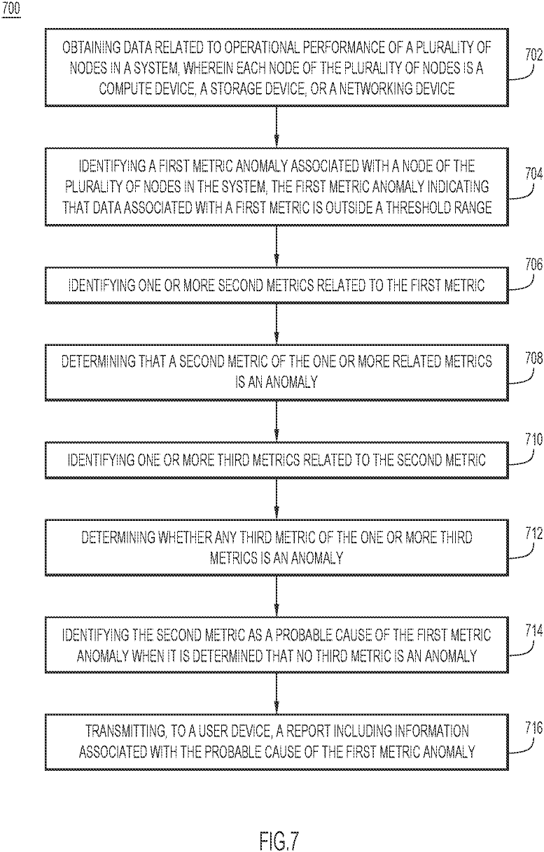

Reference is now made to FIG. 7 with continued reference to FIGS. 1-6. FIG. 7 is a flow diagram illustrating a method 700 of determining a probable cause of a performance event. Method 700 may be performed by PCA system 130 in combination with other devices, systems, and/or nodes illustrated in FIG. 1 (e.g., system 120, nodes 122-1 to 122-N, user device 110, etc.).

At 702, data related to operational performance of a plurality of nodes is obtained. Each node of the plurality of nodes is a compute device, a storage device, a networking device or associated with one or more networking services. In some embodiments, a node may be a logical entity that may map to one or more physical entities in various ways (e.g., 1:1, n:1, 1:n, etc.). At 704, a first metric anomaly associated with a node of the plurality of nodes in the system is identified. The first metric anomaly indicates that data associated with a first metric is outside a threshold range. For example, PCA system 130 may obtain an indication of a performance event indicating that a metric at a particular node is outside of a threshold range.

At 706, one or more second metrics related to the first metric are identified. For example, PCA system 130 may perform a lookup in metric relationship dictionary table 132 to identify one or more second metrics related to the first metric. At 708, it is determined that a second metric of the one or more related metrics is an anomaly. For example, PCA system 130 may perform a lookup in metric access adaptors table 134 to identify means for accessing current values for the second metrics. PCA system 130 may calculate an anomaly score for each second metric and determine that a second metric is an anomaly when the anomaly score for the second metric is outside a threshold range. PCA system 130 may store information associated with the anomaly in an anomaly capture queue.

At 710, one or more third metrics related to the second metric are identified. For example, PCA system 130 performs a lookup in metric relationship dictionary table 132 to identify one or more third metrics related to the second metric that is an anomaly. At 712, it is determined whether any third metric of the one or more third metrics is an anomaly. For example, PCA system 130 performs steps similar to the steps described to determine whether any of the third metrics is an anomaly.

At 714, the second metric is identified as a probable cause of the first metric anomaly when it is determined that no third metric is an anomaly. For example, PCA system 130 may identify the last identified anomaly as the probable cause of the first metric anomaly. In this example, when no third metric is identified as an anomaly, PCA system 130 identifies the second metric identified as an anomaly as a probable cause of the first metric anomaly.

At 716, a report including information associated with the probable cause of the first metric anomaly is transmitted to a user device. The report may include information associated with the probable cause analysis. The report may additionally include information associated with each identified anomaly (e.g., from the anomaly capture queue) and information supporting the analysis (e.g., snapshots). The report may be transmitted to a device associated with, for example, an IT department of system 120. In some embodiments, the report may include possible solutions for the performance event or information associated with actions to perform to bring the data associated with the first metric into the threshold range. In some embodiment, a configuration of one or more of the plurality of nodes in the system may be adjusted to remedy the first metric anomaly based on the information contained in the report

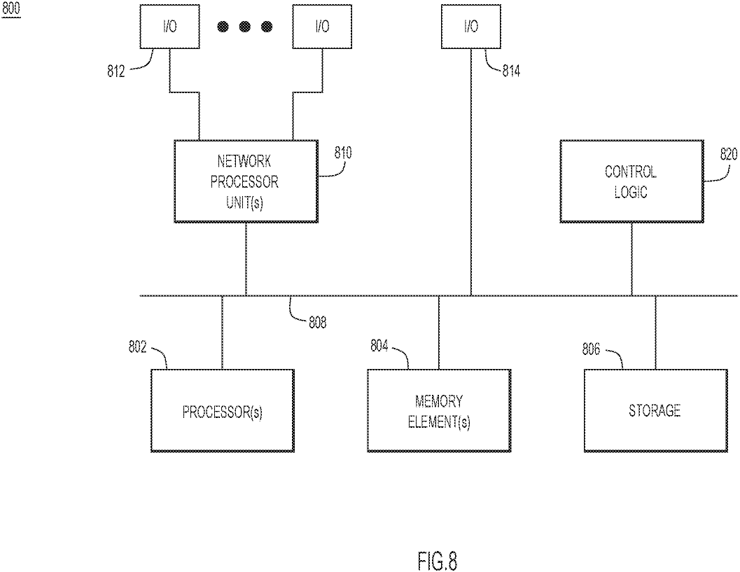

Referring to FIG. 8, FIG. 8 illustrates a hardware block diagram of a computing/computer device 800 that may perform functions of a device associated with operations discussed herein in connection with the techniques depicted in FIGS. 1 - 7. In various embodiments, a computing device, such as computing device 800 or any combination of computing devices 800, may be configured as any devices as discussed for the techniques depicted in connection with FIGS. 1 - 7 in order to perform operations of the various techniques discussed herein.

In at least one embodiment, the computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computer device 800. For example, I/O interface(s) 814 may provide a connection to external devices such as a keyboard, keypad, a touch screen, and/or any other suitable input and/or output device now known or hereafter developed. This may be the case, in particular, when the computer device 800 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, particularly when the computer device 800 serves as a user device as described herein.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided comprising obtaining data related to operational performance of a plurality of nodes in a system, wherein each node of the plurality of nodes is a compute device, a storage device, a networking device or associated with one or more networking services; identifying a first metric anomaly associated with a node of the plurality of nodes in the system, the first metric anomaly indicating that data associated with a first metric is outside a threshold range; identifying one or more second metrics related to the first metric; determining that a second metric of the one or more second metrics is an anomaly; identifying one or more third metrics related to the second metric; determining whether any third metric of the one or more third metrics is an anomaly; identifying the second metric as a probable cause of the first metric anomaly when it is determined that no third metric is an anomaly; and transmitting, to a user device, a report including information associated with the probable cause of the first metric anomaly.

In one example, identifying the one or more second metrics comprises: performing a lookup in metric relationship data to identify the one or more second metrics, the metric relationship data including a plurality of entries, each entry mapping a metric to one or more related metrics. In another example, the one or more related metrics in an entry of the plurality of entries are associated with one or more nodes of the plurality of nodes. In another example, each entry in the metric relationship data includes an indication of a metric access adaptor for the metric, the metric access adaptor being used to perform a lookup in metric access adaptor data to determine a query format to use for obtaining metric data associated with the metric. In another example, determining that the second metric is an anomaly comprises: calculating an anomaly score for the second metric based on a moving average and standard deviation; and determining that the second metric is an anomaly based on the anomaly score.

In another example, the computer-implemented method further comprises: identifying one or more fourth metrics related to a third metric of the one or more third metrics when it is determined that the third metric is an anomaly. In another example, the report includes information associated with actions to perform to bring the data associated with the first metric into the threshold range. In another example, the report includes a score for the probable cause of the first metric anomaly calculated as an aggregate of a first score associated with the first metric anomaly and a second score associated with the second metric. In another example, the computer-implemented further comprises adjusting a configuration of one or more of the plurality of nodes in the system to remedy the first metric anomaly based on the information contained in the report.

In another form, an apparatus is provided comprising a memory; a network interface configured to enable network communication; and a processor, wherein the processor is configured to perform operations comprising: obtaining data related to operational performance of a plurality of nodes in a system, wherein each node of the plurality of nodes is a compute device, a storage device, a networking device or associated with one or more networking services; identifying a first metric anomaly associated with a node of the plurality of nodes in the system, the first metric anomaly indicating that data associated with a first metric is outside a threshold range; identifying one or more second metrics related to the first metric; determining that a second metric of the one or more second metrics is an anomaly; identifying one or more third metrics related to the second metric; determining whether any third metric of the one or more third metrics is an anomaly; identifying the second metric as a probable cause of the first metric anomaly when it is determined that no third metric is an anomaly; and transmitting, to a user device, a report including information associated with the probable cause of the first metric anomaly.

In yet another form, one or more non-transitory computer readable storage media encoded with instructions that, when executed by a processor of a user device, cause the processor to execute a method comprising: obtaining data related to operational performance of a plurality of nodes in a system, wherein each node of the plurality of nodes is a compute device, a storage device, a networking device or associated with one or more networking services; identifying a first metric anomaly associated with a node of the plurality of nodes in the system, the first metric anomaly indicating that data associated with a first metric is outside a threshold range; identifying one or more second metrics related to the first metric; determining that a second metric of the one or more second metrics is an anomaly; identifying one or more third metrics related to the second metric; determining whether any third metric of the one or more third metrics is an anomaly; identifying the second metric as a probable cause of the first metric anomaly when it is determined that no third metric is an anomaly; and transmitting, to a user device, a report including information associated with the probable cause of the first metric anomaly.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

What is claimed is:

1. A computer-implemented method comprising:
obtaining data related to operational performance of a plurality of nodes in a system, wherein each node of the plurality of nodes is a compute device, a storage device, a networking device or associated with one or more networking services;
identifying a first metric anomaly associated with a node of the plurality of nodes in the system, the first metric anomaly indicating that data associated with a first metric associated with the node is outside a threshold range;
performing a lookup in a metric relationship table to identify one or more second metrics that are associated causes of and may affect the first metric anomaly associated with the node, the metric relationship table storing a plurality of entries, each entry mapping a metric and a node to at least one related metric at a second node that is an associated cause of and may affect the metric at the node;
determining that a second metric of the one or more second metrics is an anomaly;
performing a second lookup in the metric relationship table to identify one or more third metrics that are associated causes of and may affect the second metric that is an anomaly;
determining whether any third metric of the one or more third metrics is an anomaly;
identifying the second metric as a probable cause of the first metric anomaly when it is determined that no third metric is an anomaly; and
transmitting, to a user device, a report including information associated with the probable cause of the first metric anomaly.

2. (canceled)

3. The computer-implemented method of claim 1, wherein the at least one related metric in an entry of the plurality of entries is associated with one or more nodes of the plurality of nodes.

4. The computer-implemented method of claim 1, wherein each entry in the stored metric relationship table includes an indication of a metric access adaptor for the metric, the metric access adaptor being used to perform a lookup in metric access adaptor data to determine a query format to use for obtaining metric data associated with the metric.

5. The computer-implemented method of claim 1, wherein determining that the second metric is an anomaly comprises:
calculating an anomaly score for the second metric based on a moving average and standard deviation; and
determining that the second metric is an anomaly based on the anomaly score.

6. The computer-implemented method of claim 1, further comprising:
identifying one or more fourth metrics that are associated causes of and may affect a third metric of the one or more third metrics when it is determined that the third metric is an anomaly.

7. The computer-implemented method of claim 1, wherein the report includes information associated with actions to perform to bring the data associated with the first metric into the threshold range.

8. The computer-implemented method of claim 1, wherein the report includes a score for the probable cause of the first metric anomaly calculated as an aggregate of a first score associated with the first metric anomaly and a second score associated with the second metric.

9. The computer-implemented method of claim 1, further comprising adjusting a configuration of one or more of the plurality of nodes in the system to remedy the first metric anomaly based on the information contained in the report.

10. An apparatus comprising:
a memory;
a network interface configured to enable network communication; and
a processor, wherein the processor is configured to perform operations comprising:
obtaining data related to operational performance of a plurality of nodes in a system, wherein each node of the plurality of nodes is a compute device, a storage device, a networking device or associated with one or more networking services;
identifying a first metric anomaly associated with a first node of the plurality of nodes in the system, the first metric anomaly indicating that data associated with a first metric is outside a threshold range;
performing a lookup in a metric relationshiptable to identify one or more second metrics that are associated causes of and may affect the first metric and the first node, the stored metric relationshiptable storing a plurality of entries, each entry mapping a metric and a node to at least one related metric at a second node that is an associated cause of and may affect the metric at the node;
determining that a second metric of the one or more second metrics is an anomaly;
performing a second lookup in the metric relationshiptable to identify one or more third metrics that are associated causes of and may affect the second metric that is an anomaly;
determining whether any third metric of the one or more third metrics is an anomaly;
identifying the second metric as a probable cause of the first metric anomaly when it is determined that no third metric is an anomaly; and
transmitting, to a user device, a report including information associated with the probable cause of the first metric anomaly.

11. (canceled)

12. The apparatus of claim 10, wherein the at least one related metric in an entry of the plurality of entries is associated with one or more nodes of the plurality of nodes.

13. The apparatus of claim 10, wherein each entry in the metric relationshiptable includes an indication of a metric access adaptor for the metric, the metric access adaptor being used to perform a lookup in metric access adaptor data to determine a query format to use for obtaining metric data associated with the metric.

14. The apparatus of claim 10, wherein the processor is configured to perform the operation of determining that the second metric is an anomaly by:
calculating an anomaly score for the second metric based on a moving average and standard deviation; and
determining that the second metric is an anomaly based on the anomaly score.

15. The apparatus of claim 10, wherein the processor is further configured to perform operations comprising:
identifying one or more fourth metrics related to a third metric of the one or more third metrics when it is determined that the third metric is an anomaly.

16. The apparatus of claim 10, wherein the report includes information associated with actions to perform to bring the data associated with the first metric into the threshold range and a score for the probable cause of the first metric anomaly.

17. One or more non-transitory computer readable storage media encoded with instructions that, when executed by a processor of a user device, cause the processor to execute a method comprising:
obtaining data related to operational performance of a plurality of nodes in a system, wherein each node of the plurality of nodes is a compute device, a storage device, a networking device or associated with one or more networking services;
identifying a first metric anomaly associated with a first node of the plurality of nodes in the system, the first metric anomaly indicating that data associated with a first metric is outside a threshold range;
performing a lookup in a metric relationshiptable to identify one or more second metrics that are associated causes of and may affect the first metric and the first node, the stored metric relationshiptable storing a plurality of entries, each entry mapping a metric and a node to at least one related metric at a second node that is an associated cause of and may affect the metric at the node;
determining that a second metric of the one or more second metrics is an anomaly;
performing a second lookup in the metric relationshiptable to identify one or more third metrics that are associated causes of and may affect the second metric;
determining whether any third metric of the one or more third metrics is an anomaly;
identifying the second metric as a probable cause of the first metric anomaly when it is determined that no third metric is an anomaly; and
transmitting, to a user device, a report including information associated with the probable cause of the first metric anomaly.

18. (canceled)

19. The one or more non-transitory computer readable storage media of claim 17, wherein the at least one related metric in an entry of the plurality of entries is associated with one or more nodes of the plurality of nodes.

20. The one or more non-transitory computer readable storage media of claim 17, wherein determining that the second metric is an anomaly comprises:
calculating an anomaly score for the second metric based on a moving average and standard deviation; and
determining that the second metric is an anomaly based on the anomaly score.

21. The one or more non-transitory computer readable storage media of claim 17, wherein each entry in the metric relationshiptable includes an indication of a metric access adaptor for the metric, the metric access adaptor being used to perform a lookup in metric access adaptor data to determine a query format to use for obtaining metric data associated with the metric.

22. The one or more non-transitory computer readable storage media of claim 17, wherein the report includes information associated with actions to perform to bring the data associated with the first metric into the threshold range and a score for the probable cause of the first metric anomaly.

23. The one or more non-transitory computer readable storage media of claim 17, further comprising adjusting a configuration of one or more of the plurality of nodes in the system to remedy the first metric anomaly based on the information contained in the report.
